(19) United States
(12) Patent Application Publication
(10) Pub. No.: US 2024/0020666 A1
(43) Pub. Date: Jan. 18, 2024

(54) AUTOMATED BILL SHARING

(71) Applicant: Capital One Services, LLC, McLean, VA (US)

(72) Inventors: Jennifer Kwok, Brooklyn, NY (US); Ray Cheng, Long Island City, NY (US); Lukiih Cuan, Washington, DC (US)

(21) Appl. No.: 17/865,503

(22) Filed: Jul. 15, 2022

(51) Int. Cl. G06Q 20/14; G06Q 20/32

(52) U.S. Cl. CPC G06Q 20/14; G06Q 20/3224

(57) ABSTRACT

Disclosed embodiments pertain to automated bill sharing. An intent to pay a bill can be detected by detecting activation of a first payment application on a customer device near a point-of-sale device or by analyzing a customer conversation. A sharing model can be invoked to determine if the bill is to be shared with a party. The sharing model can be trained with a machine learning technique based on transaction history of the customer and party. A party device can be detected within proximity of the customer device to determine sharing or identify the party. A second payment application can be activated on the party device. The sharing model can be invoked to determine payment shares between the first and second payment applications. A shared payment can be completed to a point-of-sale device according to the payment shares, the first payment application, and the second payment application.

### BACKGROUND

Sharing bills or checks between customers or friends can be an arduous task. It becomes an awkward task to manually determine which customers pay the bill and how much each owes. Sharing a check becomes even more complicated when the customers provide a conventional payment form such as a credit card. There is increased time and effort for a bill collector to calculate and enter what each person owes and ensure each person is charged the correct amount to their payment form.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

According to one aspect, disclosed embodiments can include a method for automated bill sharing. The method can include detecting activation of a first payment application on a customer device, in which the activation indicates intent of payment of a bill by a customer, detecting a party device within proximity of the customer device, determining an intent to share the bill between the customer and a party based on detection of the party device, and triggering activation of a second payment application on the party device. The method further comprises invoking a sharing model that predicts payment shares between the first payment application and the second payment application based on a transaction history of the customer or the party and completing payment of the bill according to the payment shares wherein the first payment application is associated with a first payment service and the second payment application is associated with a second payment service. The method can further comprise invoking the sharing model to determine whether the bill is to be shared based on the transaction history. In one instance, the sharing model can correspond to a machine learning model that is trained with transaction history data. The method can also comprise recommending sharing the bill based on a conversation analysis between the customer and the party. Further, triggering activation of the second payment application can comprise installing a second payment application onto the party device or receiving an opt-in for sharing the bill from the party device. The method can also comprise detecting a proximity between the customer device and a point of sale device to confirm the intent of the payment of the bill. Additionally, the method can comprise predicting the payments shares that sum to an amount of the bill including a proportional gratuity. In one scenario, the first payment application can be associated with a first financial institution, and the second payment application can be associated with a second financial institution.

In accordance with another aspect, disclosed embodiments can include a system for automated bill sharing that comprises a processor coupled to a memory that includes instructions. When the instructions are executed by the processor, they cause the processor to analyze a conversation of a customer for identification of bill triggering words that indicate a rendering of a bill, detect activation of a first payment application on a customer device, determine an intent of the payment of the bill based on the analysis of the conversation and the activation of the first payment application, invoke a sharing model that determines an intent for sharing the payment between the customer and a party based on the detection of the first payment application, identify an association of the party and the customer based on the analysis of the conversation to identify a voice of the party; detect a party device associated with the party based on the identification of the association, and trigger installation of a second payment application on the party device. The instructions can further cause the processor to determine payment shares between the first payment application and the second payment application, in which the payment shares sum to an amount of the bill including a gratuity, send a notification of the payment shares to the customer device and the party device, and consummate payment of the bill based on confirmation of the payment shares. The instructions can also cause the processor to invoke the sharing model to determine the payment shares, in which each payment share is a proportion of the bill. In one instance, the sharing model can predict the payment shares according to a cost balancing factor. The instructions can further cause the processor to train the sharing model with a transaction history and trigger the installation of the second payment application in response to receipt of an opt-in from the party. The instructions can also cause the processor to activate the second payment application in response to receipt of an opt-in from the party device to share the bill. Further, the instructions can cause the processor to detect a proximity between the customer device and a point of sale device to confirm the intent of payment of the bill and complete the payment of the bill according to the payment shares with the first payment application and the second payment application. In one scenario, the first payment application is associated with a payment service, and the second payment application is associated with a different payment service.

In accordance with another aspect, disclosed can include a method comprising executing, on a processor, instructions that cause the processor to perform operations associated with bill sharing. The operations can include detecting a first payment application is activated on a customer device to indicate a payment of a bill by a customer, determining a sharing of the payment between the customer and a party by detecting a party device associated with an entry on a contact list of the customer device that is associated with the party, detecting the party device has activated a second payment application on the party device, training a sharing model with transaction history of the customer and the party, and determining payment shares between the first payment application and the second payment application with the sharing model. The operations can further comprise completing the payment of the bill according to the payment shares with the first payment application and the second payment application.

Aspects of disclosed embodiments provide substantial benefits with respect to automated bill sharing. One advantage resides in an automated determination of payment shares. Another advantage resides in a streamlined shared payment process.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

Aspects of the disclosure are understood from the following detailed description when read with the accompanying drawings. It will be appreciated that elements, structures, etc., of the drawings, are not necessarily drawn to scale. Accordingly, the dimensions of the same may be arbitrarily increased or reduced for clarity of discussion, for example.

FIG. 1 illustrates a high-level diagram of an example implementation.

FIG. 2 illustrates an example application view of a customer device.

FIG. 3 illustrates an example application view of a party device.

FIG. 4 illustrates an example component diagram of a bill-sharing platform.

FIG. 5 illustrates an example component diagram of a model component.

FIG. 6 illustrates a method for automated bill sharing.

FIG. 7 illustrates a computing environment where one or more of the provisions set forth herein can be implemented, according to some embodiments.

### DETAILED DESCRIPTION

Various aspects of the subject disclosure are now described in more detail with reference to the annexed drawings, wherein like reference numerals refer to like elements throughout. In the following description, for purposes of explanation, numerous specific details are set forth in order to provide a thorough understanding of aspects of the subject disclosure. It may be evident, however, that some aspects can be practiced without these specific details. In other instances, well-known structures and devices are shown in block diagram form in order to aid in clarity and understanding.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

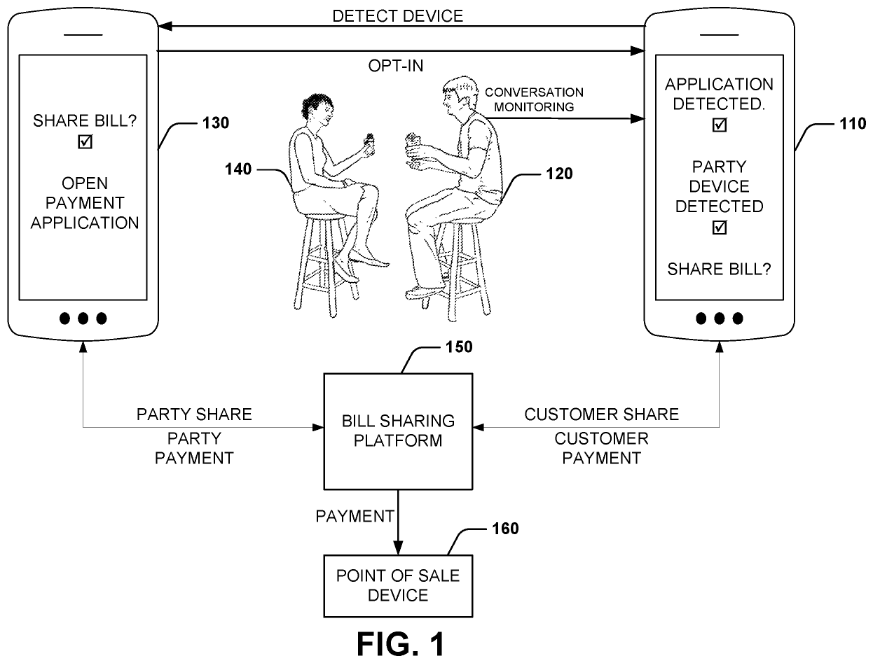

FIG. 1 illustrates a high-level view of an example implementation. A customer device 110 associated with a customer 120 can detect a payment application is activated on the customer device 110. The activation indicates that a payment of a bill is imminent or intended. The customer device 110 can be a mobile phone, Internet of things device, wearable, payment device, and/or the like. In some embodiments, the customer device 110 can determine or confirm the bill via conversation mining techniques or a conversation analysis. The customer device 110 can analyze communications of the customer 120 for key phrases or words that can indicate a bill is imminent. The customer device 110 can utilize natural language processing, optical character recognition, or the like to determine whether a bill has been rendered. In some embodiments, the customer device 110 can analyze a conversation (e.g., an audio or text-based interaction) of the customer 120 to determine that a bill has been or will be rendered to the customer 120.

The customer device 110 can detect a party device 130 associated with a party 140. The customer device 110 can detect the party device 130 is within a proximity or distance threshold of the customer device 110. The customer device 110 can detect the party device 130 via Bluetooth, Wi-Fi sharing, global positioning satellite data, location data, and/or the like. In some embodiments, the customer device 110 can detect multiple party devices for bill payment sharing.

Upon detecting the party device 130, a bill sharing platform 150 can send an opt-in notification, text, email, and/or the like to the party device 130. In some embodiments, the bill sharing platform 150 can automatically open a payment application installed on the party device 130. The bill sharing platform 150 can send an “open” command to the party device 130 to open the payment application via an application programming interface (API) call/response. The payment application can present an opt-in for sharing the bill via the party device 130. In some embodiments, the payment application is opened on the party device 130 and presents a payment share to the party 140. In some embodiments, the payment application of the customer device 110 is associated with a payment service or financial institution, and the payment application on the party device 130 is associated with a different payment service or financial institution.

In some embodiments, the bill sharing platform 150 determines whether the bill is to be shared between the customer 120 and the party 140 or the bill should be presented to either the customer 120 or the party 140. In some embodiments, the bill sharing platform 150 determines the bill is to be shared based on detection of the party device 130. In other embodiments, the bill sharing platform 150 determines sharing of the bill based on a transaction history of the customer 120 and/or the party 140. The bill sharing platform 150 determines the transaction history via interfacing with a financial institution. The bill sharing platform 150 analyzes the transaction history for trends or tendencies of the customer 120 and/or the party 140. For example, the bill sharing platform 150 can determine the customer 120 and the party 140 usually take turns paying the bill when they are together. The bill sharing platform 150 can predict that the payment is likely to be paid by the customer 120 based on an alternating transaction history of the customer 120 and the party 140 and the party 140 paid the last most recent bill.

The bill sharing platform 150 determines payment shares of the bill or payment of the bill. The payment shares the sum of a bill's total amount. In some embodiments, the payment shares the sum of a total bill amount and a proportional gratuity amount. The bill sharing platform 150 determines the payment shares based on a transaction history of the customer 120 and/or the party 140. The bill sharing platform 150 determines the transaction history via interfacing with a financial institution. The bill sharing platform 150 analyzes the transaction history for trends or tendencies of the customer 120 and/or the party 140. For example, the bill sharing platform 150 can determine the customer 120 and the party 140 usually share payments evenly when they are together and receive a bill. The bill sharing platform 150 can predict based on the transaction history that the payment is likely to be shared evenly between the customer 120 and the party 140 (e.g., payment shares of 50% to each).

The bill sharing platform 150 can interface with a point-of-sale device 160. The point of sale device 160 can be a computer, mobile device, tablet, wearable, and/or the like to complete payment from the customer 120 and/or the party 140 via their respective devices or payment means. The bill sharing platform 150 can broker a transaction from the customer device 110 and/or the party device 130 and the point of sale device 160.

The bill sharing platform 150 can complete the potential transaction via consummating a payment from the payment application installed on the customer device 110 and/or the party device 130 to the point of sale device 160. In some embodiments, the bill sharing platform 150 can consummate payment of the bill based on confirmation of the payment shares from the customer 120 and/or the party 140. The point of sale device 160 can receive at least two payments to complete payment of the bill. In some embodiments, the bill sharing platform 150 can generate and send a notification to the point of sale device 160 that a shared payment has been sent, the payment shares of the customer 120 and/or the party 140, identification of the customer 120 and/or the party 140, and/or the like. The point of sale device 160 can return a receipt or acknowledgment of a completed payment to each respective payer (e.g., the customer 120 and/or the party 140) and/or the bill sharing platform 150. In some embodiments, the point of sale device 160 and/or bill sharing platform 150 can notify the customer 120 that the party 140 has completed their payment to the point of sale device 160 and vice versa.

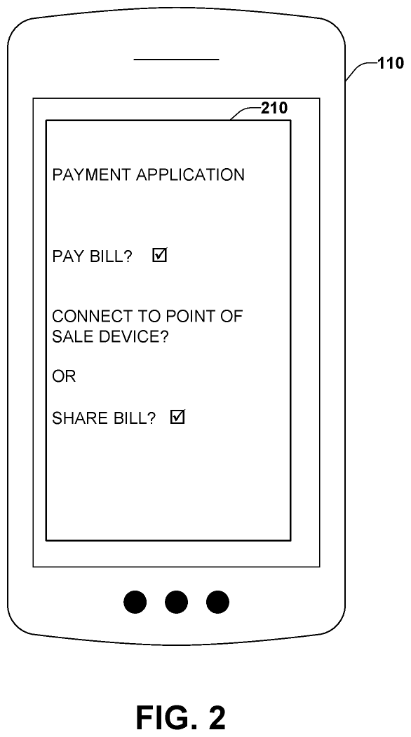

FIG. 2 illustrates an application view of the customer device 110. The customer device 110 can have a payment application 210 activated on the customer device 110. The bill sharing platform 150 can detect that the payment application 210 is active on the customer device 110 to determine payment of a bill is intended or imminent. The bill sharing platform 150 can control or interface with the payment application 210 to request whether the customer 120 wants to pay the bill and connect to the point of sale device 160 or to share the bill with a party 140. The bill sharing platform 150 can direct or utilize the customer device 110 for finding a party device 130 within proximity of the customer device 110 for sharing payment of the bill. In some embodiments, the bill sharing platform 150 can present an opt-in to the customer 120 via the customer device 110.

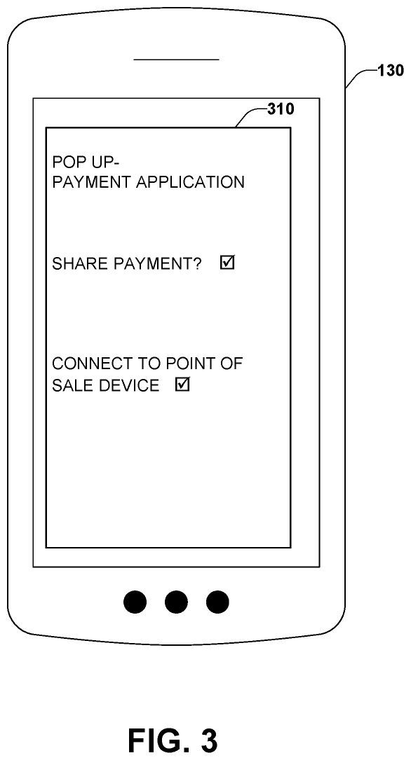

FIG. 3 illustrates an application view of the party device 130. The party device 130 can have a party payment application 310 installed on the party device 130. In some embodiments, the party payment application 310 is a matching install of the payment application 210 installed on the customer device 110. In other embodiments, the party payment application 310 differs from the payment application 210. The bill sharing platform 150 can detect the payment application 210 is active or installed on the party device 130 to determine a sharing of a bill is intended. In some embodiments, the bill sharing platform 150 can push an installation of the party payment application 310 to the party device 130. In other embodiments, the bill sharing platform 150 can provide a pop-up opt-in window to install the party payment application 310 to the party device 130. In other embodiments, the bill sharing platform 150 can provide a virtual instance of the party payment application 310 on the party device 130. The bill sharing platform 150 can control or interface with the party payment application 310 to request whether the party 140 wants to pay the bill and connect to the point of sale device 160 or to share the bill with the customer 120.

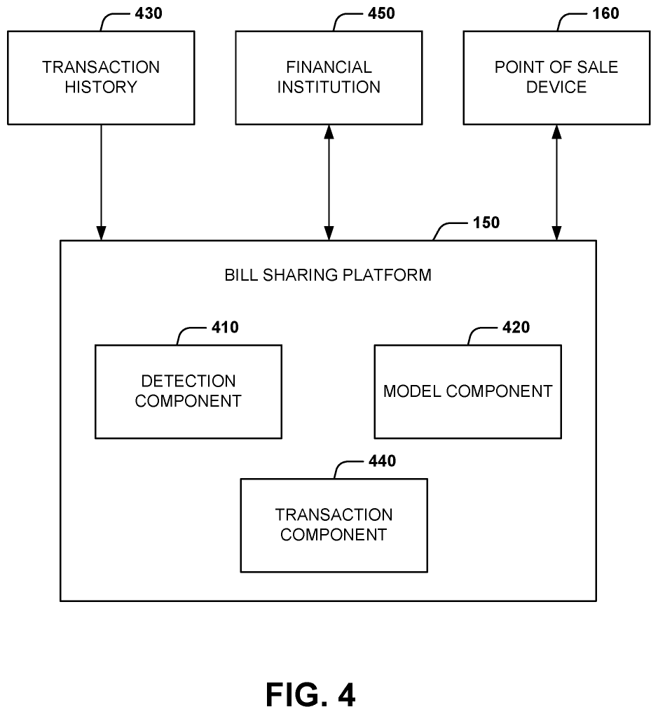

FIG. 4 illustrates a detailed component diagram of the bill sharing platform 150. The bill sharing platform 150 includes a detection component 410. The detection component 410 can determine whether a potential transaction is to be completed by a customer 120. For example, the customer 120 may be at a restaurant having a meal. The detection component 410 can determine that a bill (e.g., a check) has been rendered to the customer 120 at the end of the meal. The detection component 410 can determine the bill as a potential transaction has been rendered via a scan of the bill by a customer device 110. In some embodiments, the customer device 110 can scan a quick response code or barcode associated with the bill, a captured image of the bill, and/or the like. The detection component 410 can confirm a bill has been rendered via detection of activation of a payment application on the customer device 110. In some embodiments, the detection component 410 can confirm or infer a bill payment is imminent based on detecting a point of sale device 160 within proximity of the customer device 110.

In some embodiments, the detection component 410 can listen to a conversation of the customer 120 for bill triggering words or phrases such as “Check please?” that indicate a rendering of a bill. In some embodiments, the detection component 410 interfaces with a point of sale device 160 to determine when a bill for the customer 120 has been issued. In some embodiments, the bill is rendered digitally to the customer device 110. For example, the customer device 110 can receive the bill via an application associated with the venue, a payment application, a text message, an email, and/or the like. In other embodiments, the detection component 410 can perform biometric matching to identify the party 140. For example, the detection component 410 can identify the party 140 and/or the customer 120 via a voice matching technique to determine which party is in the company of the customer 120. The detection component 410 can cross reference the identification of the party 140 with a contact list of the customer 120 and/or the customer device 110. The detection component 410 can identify an association between the customer 120 and the party 140 by analyzing a conversation or voices. In other embodiments, the detection component 410 can determine the customer device 110 and/or the customer 120 is located in a venue where a shared bill is typically used, such as a restaurant or entertainment venue.

In some embodiments, the detection component 410 can determine bill information from the payment application. A digital bill may be presented to the customer 120 via the payment application installed on the customer device 110 and/or the point of sale device 160. The detection component 410 can extract bill information from the digital bill via interfacing with the payment application. The bill information can include but is not limited to venue name, venue location, total, items, item prices, number of patrons, server, a bill identifier, and/or the like.

In some embodiments, the detection component 410 can determine the location of the party device 130 and/or the party 140 that are within proximity of the customer 120 and/or the customer device 110. In some embodiments, the detection component 410 can detect a party device 130 associated with the party 140. For example, the detection component 410 can determine the location of the party device 130 via global positioning satellite information, wireless network data, Bluetooth detection, and/or the like in relation to the customer 120 and/or customer device 110. In some embodiments, the detection component 410 can determine that the party 140 is within proximity to the point of sale device 160.

In some embodiments, the detection component 410 can send a notification to the party 140. The notification can be an invitation to share the bill with the customer 120. In some embodiments, the notification can include an opt-in, a link, a code, a one-time passcode, and/or the like that can be used and/or presented to the party 140 to open the party payment application 310. For example, a link in the notification can automatically install or open the party payment application 310 on the party device 130 upon the party 140 following, opening, clicking, and/or the like the link in the notification. The detection component 410 can monitor for multiple party payment applications 310 and the payment application 210 of the customer device 110 to determine sharing of the bill.

The bill sharing platform 150 includes a model component 420. The model component 420 can determine and/or propose sharing the bill between the customer 120 and the party 140. The model component 420 can determine or train a sharing model to determine or predict whether the bill is to be shared and/or payment shares of the bill. The model component 420 can access and/or receive a transaction history 430 of the customer 120 and/or the party 140. The model component 420 can utilize the transaction history 430 to determine trends and/or tendencies of the customer 120 and/or the party 140.

The model component 420 can determine a trend or tendency of the customer 120 and/or the party 140. The model component 420 can learn the tendency of the customer 120 via a machine learning technique. For example, the model component 420 may analyze previous bills and transactions to determine if the customer 120 usually shares the bill at the venue, with the party 140, for bills over/under a threshold amount, or the like. In some embodiments, the model component 420 determines the sharing model via the machine learning technique. The sharing model can predict whether the customer 120 is likely to split the bill when the bill is rendered. The model component 420 determines the sharing model based on analysis of transaction history 430 (e.g., bill splitting payments). The model component 420 can train the sharing model with the associated data. The model component 420 can utilize the machine learning technique to determine trends between the customer 120, the party 140, venue, price, items, and/or the like across a history of transactions. The model component 420 learns from existing data to make predictions about the current bill that is rendered. The model component 420 builds the sharing model from the history (e.g., “training data set”) in order to make data-driven predictions or decisions expressed as outputs or assessments for the customer 120 and/or the party 140. The model component 420 can determine the trends and/or correlations within the transaction history 430. In some embodiments, the model component 420 utilizes the machine learning technique to analyze the historical data across similar users, contacts, services, venues, and/or the like to determine a sharing model based on correlations in transaction history 430.

In some embodiments, the model component 420 can determine whether a bill will be shared through a conversation mining model. For example, the model component 420 can analyze correspondence or conversations between the customer 120 and the party 140 to determine whether a plan to share the bill has been conceived. For example, the customer 120 can state, “Want to split the bill evenly?” The model component 420 can determine that the customer 120 and the party 140 will share the bill with equal payment shares to each person.

In some embodiments, the model component 420 predicts payment shares of the customer 120 and/or the party 140. The model component 420 can determine or establish the payment shares via the sharing model that is trained using the machine learning technique. The payment shares provide a payment responsibility for the customer 120 and/or the party 140 (or multiple parties). In some embodiments, the model component 420 can train the sharing model via the transaction history 430, which includes transaction data such as previous payment shares, shared bills between the customer 120 and the party 140, bills at the venue, consumption trends of the customer 120 and/or the party 140, and/or the like. The model component 420 can determine the trends and correlations to train the sharing model to predict the payment shares. For example, the model component 420 can learn from the transaction history that the customer 120 and the party 140 usually share the cost of a bottle of wine while each pays for their own food at a restaurant. In some embodiments, the model component 420 can learn from the transaction history that the customer 120 usually provides a certain percentage as a tip or gratuity while the party 140 usually provides a different percentage. The model component 420 can adjust payment shares or amount totals accordingly. The model component 420 via the sharing model can determine or recommend the payment share to be attributed to the customer 120 and the payment share to be attributed to the party 140 accordingly.

The bill sharing platform 150 includes a transaction component 440. The transaction component 440 can provide the payment shares to the customer 120 and/or the party 140. The transaction component 440 can provide a notification of the payment share to the payment application installed on the customer device 110 and/or to the party payment application of the party device 130. For example, the model component 420 can determine that a payment share of $40 is attributed to the customer 120, and a payment share of $30 is attributed to the party 140. The transaction component 440 generates and sends a notification to the customer device 110 and a second notification to the party device 130. The transaction component 440 can interface with the payment application and/or the party payment application to provide a push notification of the payment shares, auto-generate a payment to the point of sale device 160, and/or the like.

The transaction component 440 can complete a payment from each device to the point of sale device 160. The point of sale device 160 can receive at least two payments to complete payment of the bill. In some embodiments, the transaction component 440 can generate and send a notification to the point of sale device 160 that a shared payment has been sent, the payment shares of each person, an identification of the customer 120 and/or the party 140, and/or the like. The point of sale device 160 or a financial institution 450 can return a receipt or acknowledgment of a completed payment to each respective payer (e.g., the customer 120 and party 140) and/or the bill sharing platform 150. In some embodiments, the point of sale device 160 and/or transaction component 440 can provide a notification to the customer 120 that the party 140 has completed payment of their payment share to the point of sale device 160 and vice versa. The transaction component 440 can complete the transaction between the point of sale device 160 and the financial institution 450 associated with the customer 120.

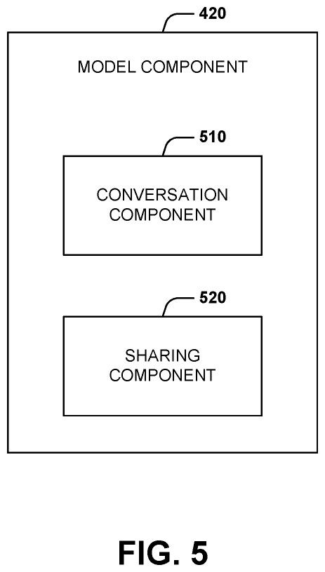

FIG. 5 illustrates a component diagram of a model component 420. The model component 420 includes a conversation component 510. The conversation component 510 can determine whether a bill will be shared via a conversation mining model. For example, the conversation component 510 can analyze correspondence or conversations between the customer 120 and the party 140 to determine whether a plan to share the bill has been conceived. The conversation component 510 can listen, record, or stream in real time or near real time to spoken conversations of the customer 120, the party 140, a third party, and/or the like. For example, the customer 120 can state, “It is my turn to pay for dinner!” The model component 420 can determine that the customer 120 and the party 140 will not share the bill and that 100% of the payment share will be attributed to the customer 120.

In some embodiments, the conversation component 510 can read or access text-based conversations of the customer 120 and/or the party 140. The conversation component 510 can utilize artificial intelligence, data mining, natural language processing, optical character recognition, machine learning, and/or the like to determine the intent of text-based conversations. The conversation component 510 can access text messages, emails, and/or the like. In other embodiments, the conversation component 510 can access a calendar, meeting invitation, and/or the like. The conversation component 510 can determine a shared bill by analyzing data factors such as attendees, calendar updates, meeting organization, business relationship, and/or the like. The conversation component 510 can analyze the data factors to determine a sharing of the bill. For example, the conversation component 510 can determine a calendar of the customer 120 includes a sales meeting organized by the party 140. The conversation component 510 can determine that the party 140 is likely to pay the bill as the meeting organizer or initiator of the meeting with the customer 120.

The model component 420 includes a sharing component 520. The sharing component 520 can determine and/or propose sharing the bill between the customer 120 and the party 140 via a sharing model. The sharing component 520 can determine or train the sharing model to determine whether the bill is to be shared, and/or payment shares of the bill. The sharing component 520 can access and/or receive a transaction history 430 of the customer 120 and/or the party 140. The sharing component 520 can utilize the transaction history 430 to determine trends and/or tendencies of the customer 120 and/or the party 140.

The sharing component 520 can determine a trend or tendency of the customer 120 and/or the party 140. The sharing component 520 can learn the tendency of the customer 120 via a machine learning technique. For example, the sharing component 520 may analyze previous bills and transactions to determine if the customer 120 usually shares the bill at the venue, with the party 140, for bills over/under a threshold amount, and/or the like. In some embodiments, the sharing component 520 determines the sharing model via the machine learning technique. The sharing model can predict whether the customer 120 is likely to split the bill when the bill is rendered. The sharing component 520 determines the sharing model based on analysis of transaction history 430 (e.g., bill splitting payments). The sharing component 520 can train the sharing model via the associated data. The sharing component 520 can utilize the machine learning technique to determine trends between the customer 120, the party 140, venue, price, items, and/or the like across a history of transactions. The sharing component 520 learns from existing data to make predictions about the current bill that is rendered. The sharing component 520 builds the sharing model from the history (e.g., “training data set”) in order to make data-driven predictions or decisions expressed as outputs or assessments for the customer 120 and/or the party 140. The sharing component 520 can determine the trends and/or correlations within the transaction history 430. In some embodiments, the sharing component 520 utilizes the machine learning technique to analyze the historical data across similar users, contacts, services, venues, and/or the like to determine a sharing model based on correlations in the transaction history 430.

In some embodiments, the sharing component 520 can predict payment shares of the customer 120 and/or the party 140. The sharing component 520 can determine payment shares via the sharing model that is trained using the machine learning technique. The payment shares provide a payment responsibility for the customer 120 and/or the party 140 (or multiple parties). In some embodiments, the sharing component 520 can train the sharing model via the transaction history 430, which includes transaction data such as previous payment shares, shared bills between the customer 120 and the party 140, bills at the venue, consumption trends of the customer 120 and/or the party 140, and/or the like. The sharing component 520 can determine the trends and correlations to train the sharing model to predict the payment shares. For example, the sharing component 520 can learn from the transaction history that the customer 120 and the party 140 shared the last three bills with 60% attributed to the customer 120 and 40% attributed to the party 140. The sharing component 520 via the sharing model can determine the payment share to be attributed to the customer 120 and the payment share to be attributed to the party 140 accordingly.

In some embodiments, the sharing component 520 can determine a cost balancing factor for the sharing model based on the transaction history 430. The cost balancing factor can affect the payment shares. For example, the transaction history 430 can reveal that the customer 120 paid for coffee for the customer 120 and the party 140 the most recent transaction, while the party 140 paid for dinner as the next most recent transaction. The sharing component 520 via the sharing model can adjust payment shares according to the cost balancing factor to balance the payments.

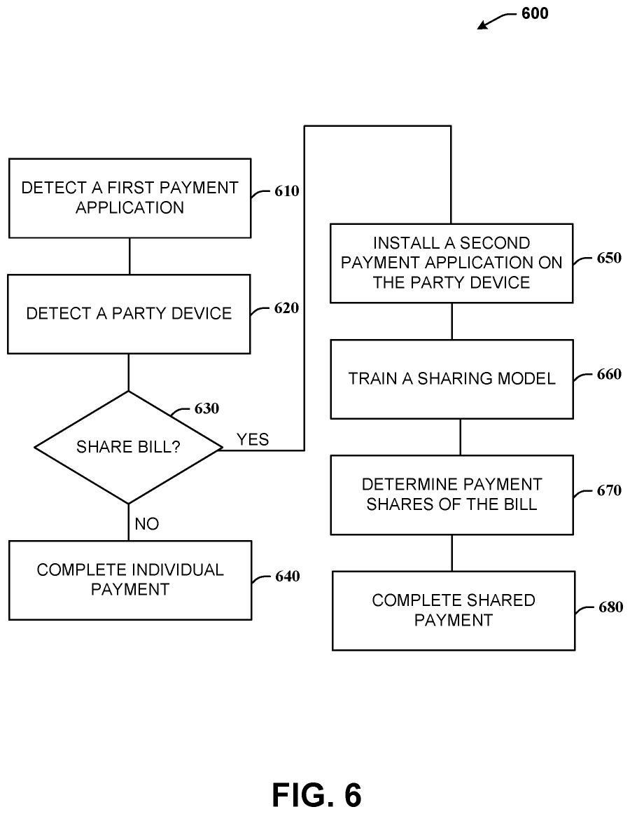

With reference to FIG. 6, example method 600 is depicted for automated bill sharing. While, for purposes of simplicity of explanation, the methods show and describe a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block. It is also to be appreciated that the method 600 is described in conjunction with a specific example for explanation purposes.

FIG. 6 illustrates a method 600 for automated bill sharing. At 610, a first payment application residing on a customer device 110 can be detected to indicate that a bill payment is intended and/or imminent. For example, the bill sharing platform 150 can detect that the payment application is activate or opened on the customer device 110. The bill sharing platform 150 can determine a bill upon detecting the payment application. At 620, a party device can be detected. The bill sharing platform 150 via the customer device 110 can detect the party device 130. The party device 130 can be detected over Wi-Fi, Bluetooth, GPS, location tracking, and/or the like.

At 630, a determination to share the bill is decided. The bill sharing platform 150 can send a notification to the party device 130 to opt into sharing the bill. In some embodiments, the bill sharing platform 150 can determine the bill is to be shared via a sharing model trained using a transaction history. If it is determined that there is no sharing of the bill, at 640, the bill sharing platform 150 can complete an individual payment of the bill. The bill sharing platform 150 can complete payment via the first payment application.

If the bill is determined to be shared between the party and the customer, at 650, a second payment application can be installed and/or activated on the party device. The bill sharing platform 150 can interface with the party device 130 to install an instance of the second payment application, open a website of the second payment application, open an already installed second payment application, open a virtual instance of the second payment application, and/or the like. At 660, a sharing model can be trained. The bill sharing platform 150 can train the sharing model via a machine learning technique using transaction history of the customer 120 and/or the party 140 as a training data set. At 670, payment shares of the bill are determined or calculated. The bill sharing platform 150 can determine payment shares via the sharing model trained with the transaction history. At 680, a shared payment of the bill can be completed. The bill sharing platform 150 can complete separate payments from the first payment application and the second payment application respectively to a point-of-sale device 160.

As used herein, the terms “component” and “system,” as well as various forms thereof (e.g., components, systems, sub-systems), are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having,” or variations in form thereof are used in either the detailed description or the claims, such terms are intended to be inclusive in a manner similar to the term “comprising” as “comprising” is interpreted when employed as a transitional word in a claim.

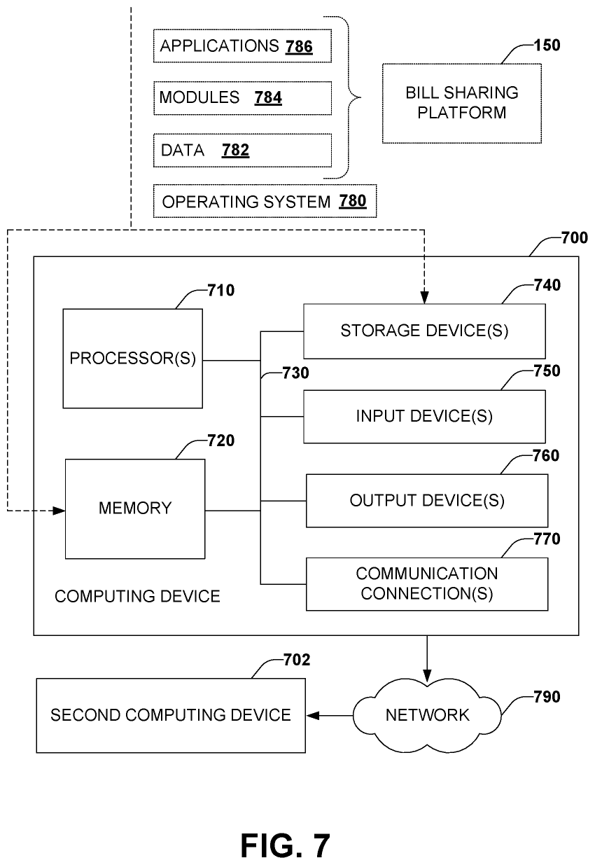

To provide a context for the disclosed subject matter, FIG. 7, as well as the following discussion, are intended to provide a brief, general description of a suitable environment in which various aspects of the disclosed subject matter can be implemented. The suitable environment, however, is solely an example and is not intended to suggest any limitation as to the scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, and data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 7, illustrated is an example computing device 700 (e.g., desktop, laptop, tablet, watch, server, hand-held, programmable consumer or industrial electronics, set-top box, game system, compute node . . . ). The computing device 700 includes one or more processor(s) 710, memory 720, system bus 730, storage device(s) 740, input device(s) 750, output device(s) 760, and communications connection(s) 770. The system bus 730 communicatively couples at least the above system constituents. However, the computing device 700, in its simplest form, can include one or more processors 710 coupled to memory 720, wherein the one or more processors 710 execute various computer executable actions, instructions, and or components stored in the memory 720.

The processor(s) 710 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 710 may also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 710 can be a graphics processor unit (GPU) that performs calculations with respect to digital image processing and computer graphics.

The computing device 700 can include or otherwise interact with a variety of computer-readable media to facilitate control of the computing device to implement one or more aspects of the disclosed subject matter. The computer-readable media can be any available media that is accessible to the computing device 700 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 700. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 720 and storage device(s) 740 are examples of computer-readable storage media. Depending on the configuration and type of computing device, the memory 720 may be volatile (e.g., random access memory (RAM)), nonvolatile (e.g., read only memory (ROM), flash memory) or some combination of the two. By way of example, the basic input/output system (BIOS), including basic routines to transfer information between elements within the computing device 700, such as during start-up, can be stored in nonvolatile memory, while volatile memory can act as external cache memory to facilitate processing by the processor(s) 710, among other things.

The storage device(s) 740 include removable/non-removable, volatile/nonvolatile storage media for storage of vast amounts of data relative to the memory 720. For example, storage device(s) 740 include, but are not limited to, one or more devices such as a magnetic or optical disk drive, floppy disk drive, flash memory, solid-state drive, or memory stick.

Memory 720 and storage device(s) 740 can include, or have stored therein, operating system 780, one or more applications 786, one or more program modules 784, and data 782. The operating system 780 acts to control and allocate resources of the computing device 700. Applications 786 include one or both of system and application software and can exploit management of resources by the operating system 780 through program modules 784 and data 782 stored in the memory 720 and/or storage device(s) 740 to perform one or more actions. Accordingly, applications 786 can turn a general-purpose computer 700 into a specialized machine in accordance with the logic provided thereby.

All or portions of the disclosed subject matter can be implemented using standard programming and/or engineering techniques to produce software, firmware, hardware, or any combination thereof to control the computing device 700 to realize the disclosed functionality. By way of example and not limitation, all or portions of the bill sharing platform 150 can be, or form part of, the application 786, and include one or more modules 784 and data 782 stored in memory and/or storage device(s) 740 whose functionality can be realized when executed by one or more processor(s) 710.

In accordance with one particular embodiment, the processor(s) 710 can correspond to a system on a chip (SOC) or like architecture including, or in other words integrating, both hardware and software on a single integrated circuit substrate. Here, the processor(s) 710 can include one or more processors as well as memory at least similar to the processor(s) 710 and memory 720, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the bill sharing platform 150 and/or functionality associated therewith can be embedded within hardware in a SOC architecture.

The input device(s) 750 and output device(s) 760 can be communicatively coupled to the computing device 700. By way of example, the input device(s) 750 can include a pointing device (e.g., mouse, trackball, stylus, pen, touchpad), keyboard, joystick, microphone, voice user interface system, camera, motion sensor, and a global positioning satellite (GPS) receiver and transmitter, among other things. The output device(s) 760, by way of example, can correspond to a display device (e.g., liquid crystal display (LCD), light emitting diode (LED), plasma, organic light-emitting diode display (OLED)), speakers, voice user interface system, printer, and vibration motor, among other things. The input device(s) 750 and output device(s) 760 can be connected to the computing device 700 by way of wired connection (e.g., bus), wireless connection (e.g., Wi-Fi, Bluetooth), or a combination thereof.

The computing device 700 can also include communication connection(s) 770 to enable communication with at least a second computing device 702 by means of a network 790. The communication connection(s) 770 can include wired or wireless communication mechanisms to support network communication. The network 790 can correspond to a local area network (LAN) or a wide area network (WAN) such as the Internet. The second computing device 702 can be another processor-based device with which the computing device 700 can interact. For example, the computing device 700 can correspond to a server that executes functionality of the bill sharing platform 150, and the second computing device 702 can be a user device that communicates and interacts with the computing device 700.

What has been described above includes examples of aspects of the claimed subject matter. Of course, it is impossible to describe every conceivable combination of components or methods to describe the claimed subject matter. However, one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method for automated bill sharing, comprising:
detecting activation of a first payment application on a customer device, wherein the activation indicates intent of a payment of a bill by a customer;
detecting a party device within proximity of the customer device;
determining an intent to share the bill between the customer and a party based on detection of the party device;
triggering activation of a second payment application on the party device;
invoking a sharing model that predicts payment shares between the first payment application and the second payment application based on a transaction history of the customer or the party; and
completing payment of the bill according to the payment shares wherein the first payment application is associated with a first payment service and the second payment application is associated with a second payment service.

2. The method of claim 1, further comprising invoking the sharing model to determine whether the bill is to be shared based on the transaction history.

3. The method of claim 2, further comprising training a machine-learning-based sharing model with the transaction history.

4. The method of claim 1, further comprising recommending sharing the bill based on a conversation analysis between the customer and the party.

5. The method of claim 1, wherein triggering activation of the second payment application comprises installing the second payment application onto the party device.

6. The method of claim 1, wherein triggering activation of the second payment application comprises receiving an opt-in for sharing the bill from the party device.

7. The method of claim 1, further comprising detecting a proximity between the customer device and a point of sale device to confirm the intent of the payment of the bill.

8. The method of claim 1, further comprising predicting the payment shares that sum to an amount of the bill including a proportional gratuity.

9. The method of claim 1, wherein the first payment application is associated with a first financial institution and the second payment application is associated with a second financial institution.

10. A system for automated bill sharing, comprising:
a processor coupled to a memory that includes instructions that, when executed by the processor, cause the processor to:
analyze a conversation of a customer for identification of bill triggering words that indicate a rendering of a bill;
detect activation of a first payment application on a customer device;
determine an intent of the payment of the bill based on analysis of the conversation and the activation of the first payment application;
invoke a sharing model that determines an intent for sharing the payment between the customer and a party based on the detection of the first payment application;
identify an association of the party and the customer based on the analysis of the conversation to identify a voice of the party;
detect a party device associated with the party based on the identification of the association;
trigger installation of a second payment application on the party device;
determine payment shares between the first payment application and the second payment application, wherein the payment shares sum to an amount of the bill including a gratuity;
send a notification of the payment shares to the customer device and the party device; and
consummate payment of the bill based on confirmation of the payment shares.

11. The system of claim 10, wherein the instructions further cause the processor to invoke the sharing model to determine the payment shares, wherein each payment share is a proportion of the bill.

12. The system of claim 11, wherein the sharing model predicts the payment shares according to a cost balancing factor.

13. The system of claim 10, wherein the instructions further cause the processor to train the sharing model with a transaction history.

14. The system of claim 10, wherein the instructions further cause the processor to trigger the installation of the second payment application in response to receipt of an opt-in from the party.

15. The system of claim 10, wherein the instructions further cause the processor to activate the second payment application in response to receipt of an opt-in from the party device to share the bill.

16. The system of claim 10, wherein the instructions further cause the processor to detect a proximity between the customer device and a point of sale device to confirm the intent of the payment of the bill.

17. The system of claim 10, wherein the instructions further cause the processor to complete the payment of the bill according to the payment shares with the first payment application and the second payment application.

18. The system of claim 10, wherein the first payment application is associated with a payment service and the second payment application is associated with a different payment service.

19. A method for automated bill sharing, comprising:
executing, on a processor, instructions that cause the processor to perform operations, the operations comprising:
detecting a first payment application is activated on a customer device to indicate a payment of a bill by a customer;
determining a sharing of the payment between the customer and a party by detecting a party device associated with an entry on a contact list of the customer device that is associated with the party;
detecting the party device has activated a second payment application on the party device;
training a sharing model with transaction history of the customer and the party; and
determining payment shares between the first payment application and the second payment application with the sharing model.

20. The method of claim 19, wherein the operations further comprise completing the payment of the bill according to the payment shares with the first payment application and the second payment application.
